(19) United States
(12) Patent Application Publication
(10) Pub. No.: US 2026/0282110 A1
(43) Pub. Date: Sep. 17, 2026

(54) DETERMINATION OF BEAMS FOR TRANSMISSIONS BY A UE IN INITIAL ACCESS

(71) Applicant: Samsung Electronics Co., Ltd., Suwon-si (KR)

(72) Inventors: Carmela Cozzo, San Diego, CA (US); Aristides Papasakellariou, Houston, TX (US)

(21) Appl. No.: 19/675,052

(22) Filed: May 12, 2026

Related U.S. Application Data
(63) Continuation of application No. 18/401,214, filed on Dec. 29, 2023.
(60) Provisional application No. 63/438,172, filed on Jan. 10, 2023.

(51) Int. Cl. H04W 74/0833; H04L 1/00; H04W 16/28; H04W 72/1268

(52) U.S. Cl. CPC H04W 74/0833; H04L 1/0003; H04W 16/28; H04W 72/1268

(57) ABSTRACT

Methods and apparatuses for beam determination in random access in a wireless communication system a method performed by a user equipment (UE) includes receiving a system information block (SIB) indicating a first number of spatial settings, a set of random access channel occasions (ROs), and a set of numbers of repetitions for transmission of a physical random access channel (PRACH). The method further includes determining a number of repetitions, from the set of numbers of repetitions, for the PRACH transmission, a subset of ROs, from the set of ROs, corresponding to the number of repetitions, and a set of spatial settings having a one-to-one association with the subset of ROs based on a mapping between the first number of spatial settings and a number of ROs in the subset of ROs. The method further includes transmitting the PRACH over the subset of ROs using the set of spatial settings.

### CROSS-REFERENCE TO RELATED APPLICATIONS AND CLAIM OF PRIORITY

The present application is a continuation of U.S. patent application Ser. No. 18/401,214 filed on Dec. 29, 2023, which claims priority under 35 U.S.C. § 119 (e) to U.S. Provisional Patent Application No. 63/438,172 filed Jan. 10, 2023. The contents of the above-identified patent document is incorporated herein by reference.

### TECHNICAL FIELD

The present disclosure relates generally to wireless communication systems and, more specifically, the present disclosure relates to beam determination in random access in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to beam determination in random access in a wireless communication system.

In one embodiment, a user equipment (UE) is provided. The UE includes a transceiver configured to receive a system information block (SIB) indicating a first number of spatial settings M, a set of random access channel occasions (ROs), and a set of numbers of repetitions for transmission of a physical random access channel (PRACH). The UE further includes a processor operably coupled to the transceiver. The processor is configured to determine a number of repetitions, from the set of numbers of repetitions, for the PRACH transmission, a subset of ROs, from the set of ROs, corresponding to the number of repetitions, and a set of spatial settings having a one-to-one association with the subset of ROs based on a mapping between the first number of spatial settings M and a number of ROs N in the subset of ROs. The transceiver is further configured to transmit the PRACH over the subset of ROs using the set of spatial settings.

In another embodiment, a base station (BS) is provided. The BS includes a transceiver configured to transmit a SIB indicating: a first number of spatial settings M, a set of ROs, and a set of numbers of repetitions for reception of a PRACH. The BS further includes a processor operably coupled to the transceiver. The processor is configured to determine a number of repetitions, from the set of numbers of repetitions, for the PRACH reception, a subset of ROS, from the set of ROs, corresponding to the number of repetitions, and a set of spatial settings having a one-to-one association with the subset of ROs based on a mapping between the first number of spatial settings M and a number of ROs N in the subset of ROs. The transceiver is further configured to receive the PRACH over the subset of ROs using the set of spatial settings.

In yet another embodiment, a method performed by a UE is provided. The method includes receiving a SIB indicating a first number of spatial settings M, a set of ROs, and a set of numbers of repetitions for transmission of a PRACH. The method further includes determining a number of repetitions, from the set of numbers of repetitions, for the PRACH transmission, a subset of ROs, from the set of ROs, corresponding to the number of repetitions, and a set of spatial settings having a one-to-one association with the subset of ROs based on a mapping between the first number of spatial settings M and a number of ROs N in the subset of ROs. The method further includes transmitting the PRACH over the subset of ROs using the set of spatial settings.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6 illustrates a flowchart of a UE procedure for determining spatial settings and ROs for transmission of multiple PRACHs according to embodiments of the present disclosure;

FIG. 7 illustrates a flowchart of another UE procedure for determining spatial settings and ROs for transmission of multiple PRACHs according to embodiments of the present disclosure;

FIG. 8 illustrates a flowchart of a UE procedure for determining a spatial setting for transmission of message 3 (Msg3) PUSCH with repetitions according to embodiments of the present disclosure;

FIG. 9 illustrates a flowchart of a UE procedure for determining a spatial setting for a Msg3 physical uplink shared channel (PUSCH) transmission that is scheduled by an uplink (UL) grant in a random access response (RAR) message according to embodiments of the present disclosure;

FIG. 10 illustrates a flowchart of a UE procedure for indicating a spatial setting used for Msg3 PUSCH transmission according to embodiments of the present disclosure;

FIG. 11 illustrates a flowchart of a UE procedure for determining a spatial setting for a Msg3 PUSCH transmission that is scheduled by an UL grant in a RAR message according to embodiments of the present disclosure;

FIG. 12 illustrates a flowchart of a UE procedure for transmitting a physical uplink control channel (PUCCH) before dedicated PUCCH resource configuration is provided using a spatial setting indicated by bits of a hybrid automatic repeat request (HARQ) process number field in a downlink control information (DCI) format scheduling a physical downlink shared channel (PDSCH) reception according to embodiments of the present disclosure;

FIG. 13 illustrates a flowchart of a UE procedure for transmitting a PUCCH before dedicated PUCCH resource configuration is provided using a number of repetitions and a spatial setting that are indicated by a DCI format scheduling a PDSCH reception, wherein the DCI format is with a cyclic redundancy check (CRC) scrambled by a temporary cell-radio network temporary identifier (TC-RNTI) and the PDSCH reception includes a UE contention resolution identity according to embodiments of the present disclosure; and

FIG. 14 illustrates a flowchart of a UE procedure for transmitting a PUCCH before dedicated PUCCH resource configuration is provided using a number of repetitions and an associated spatial setting according to embodiments of the present disclosure.

### DETAILED DESCRIPTION

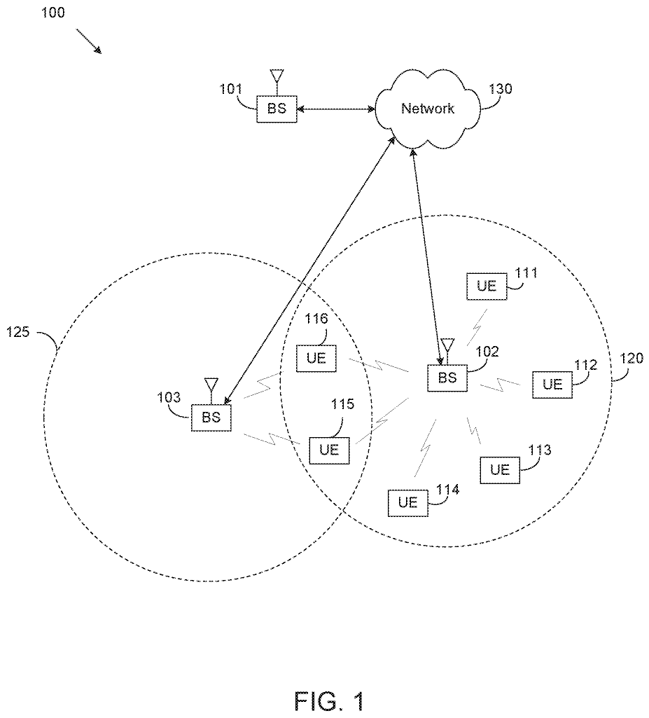

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: 3GPP TS 38.211 v17.3.0, “NR; Physical channels and modulation” (herein “REF 1”); 3GPP TS 38.212 v17.3.0, “NR; Multiplexing and Channel coding” (herein “REF 2”); 3GPP TS 38.213 v17.3.0, “NR; Physical Layer Procedures for Control” (herein “REF 3”); 3GPP TS 38.214 v17.3.0, “NR; Physical Layer Procedures for Data” (herein “REF 4”); 3GPP TS 38.321 v17.2.0, “NR; Medium Access Control (MAC) protocol specification” (herein “REF 5”); and 3GPP TS 38.331 v17.2.0, “NR; Radio Resource Control (RRC) Protocol Specification” (herein “REF 6”).

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, to for beam determination in random access in a wireless communication system. In certain embodiments, and one or more of the gNBs 101-103 includes circuitry, programing, or a combination thereof, to support beam determination in random access in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

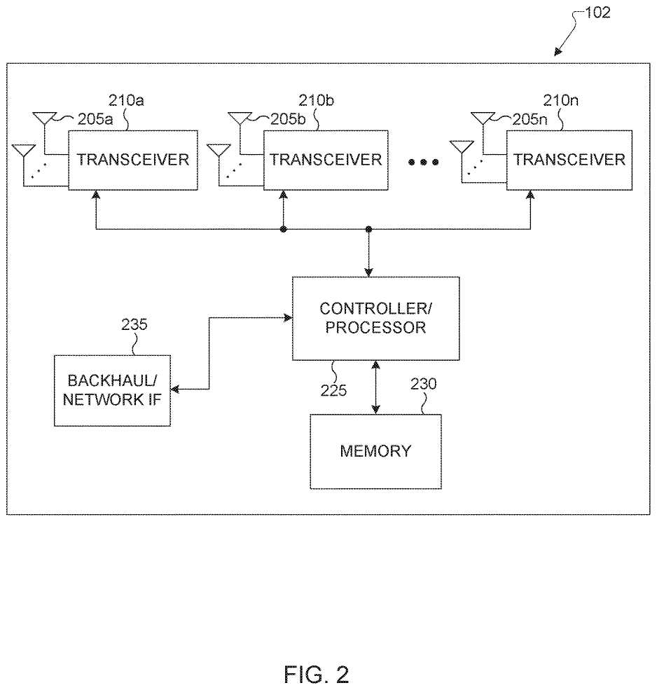

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process. The controller/processor 225 is also capable of executing programs and other processes resident in the memory 230, such as processes to support beam determination in random access in a wireless communication system.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

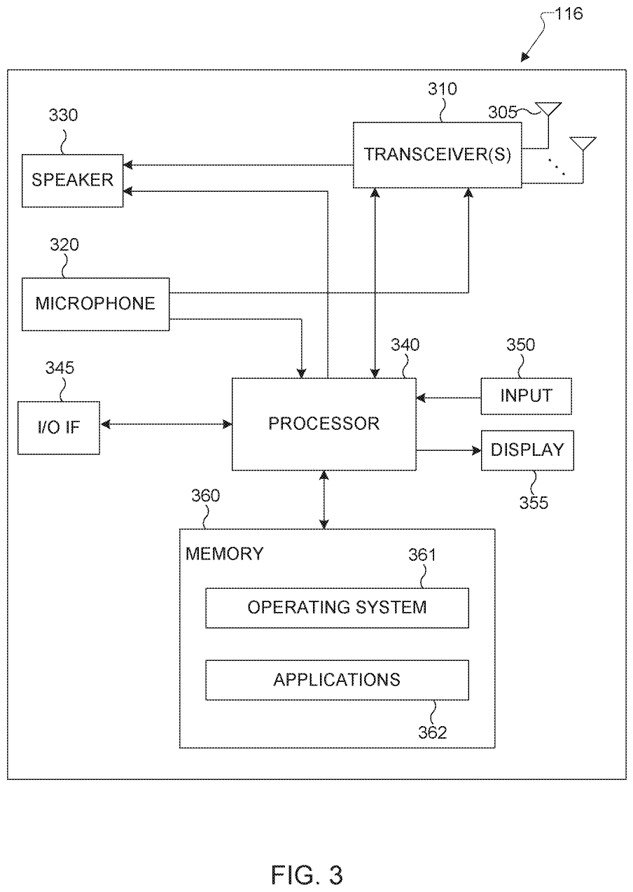

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for beam determination in random access in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

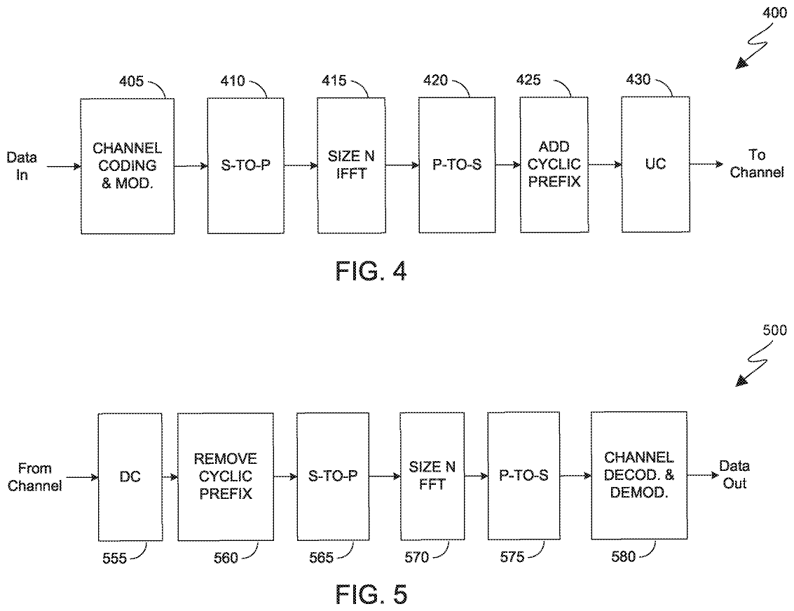

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support beam determination in random access in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

In wireless communication systems, when a random access response (RAR) is successfully received by the UE in response to multiple physical random access channel (PRACH) transmissions using same or different spatial settings, the UE transmits a Msg3 physical uplink shared channel (PUSCH) that is scheduled by an UL grant in the RAR. For multiple PRACH transmissions transmitted using same spatial settings in a number of random access channel (RACH) occasions (ROs) or in a group of ROs associated to a same synchronization signal/physical broadcast channel (SS/PBCH) block, the UE can transmit the Msg3 PUSCH using the same spatial setting used for the multiple PRACH transmissions. For multiple PRACH transmissions, or repetitions of a same PRACH preamble, that use different spatial settings in a number of ROs or in a group of ROs associated to a same SS/PBCH block, there is a need for the UE to determine the spatial setting for each repetition of the PRACH transmission in a corresponding RO and to determine the spatial setting for the transmission of the Msg3 PUSCH so that the Msg3 PUSCH can be correctly received by the gNB.

A random access (RA) procedure can be initiated to fulfill several purposes including for example one of the following: establish radio resource control (RRC) connection (e.g., to go from RRC_IDLE to RRC_CONNECTED), re-establish RRC connection after radio link failure (RLF), on-demand system information (SI) request, UL synchronization, scheduling request (SR), positioning, and link recovery (also known as beam failure recovery (BFR)). A physical random access procedure is triggered upon request of a PRACH transmission by higher layers at a UE or by a physical downlink control channel (PDCCH) order from a serving gNB. RA can operate in two modes: (i) contention-based random access (CBRA) where UEs within a serving cell can share same RA resources and there is therefore a possibility of collision among RA attempts from different UEs, and (ii) contention-free random access (CFRA) where a UE has dedicated RA resources that can be, for example, indicated by a serving gNB and may not be shared with other UEs so that RA collisions can be avoided.

A 4-step random access procedure, also known as a Type-1 L1 random access procedure includes step-1: UE transmission of a PRACH preamble (Msg1); step-2: gNB transmission of RAR message with a PDCCH/physical downlink shared channel (PDSCH) (Msg2); step-3: UE transmission of a contention resolution message and when applicable, the transmission of a PUSCH scheduled by a RAR UL grant (Msg3); and step-4: gNB transmission of a contention resolution message (Msg4).

Regarding step-1, prior to initiation of the physical random access procedure, Layer 1 of a UE receives from higher layers a set of SS/PBCH block indexes and provides to higher layers a corresponding set of reference signal received power (RSRP) measurements. Layer 1 receives the configuration of PRACH transmission parameters (PRACH preamble format, time resources, and frequency resources for PRACH transmission). In step-1, the UE transmits a PRACH using the selected PRACH format with a transmission power determined depending on whether the PRACH transmission is triggered upon request by higher layers or is in response to a detection of a PDCCH order from a serving gNB, and depending on the action associated with the PDCCH order.

Regarding step-2, random access response (RAR or Msg2) in step-2 is a PDCCH/PDSCH transmission that the UE receives on a DL bandwidth part (BWP): the initial DL BWP of the PCell/SpCell for the case of initial access, i.e., (re-) establishing RRC connection, or the active DL BWP (with the same BWP-index as the active UL BWP) of an SpCell for other random access triggers except for initial access. If the active DL BWP index (of the SpCell) is not equal to active UL BWP index (of the serving cell), then the active DL BWP is switched to one with the same BWP index. The sub-carrier spacing (SCS) for PDCCH in RAR message is the SCS for Type1-PDCCH CSS set. The PDCCH scheduling the PDSCH with the RAR provides a DCI format 1_0 and the UE monitors PDCCH candidates during a configured time window in a Type1-PDCCH common search space (CSS) set of the SpCell identified by the RA-RNTI or, for the case of BFR with CFRA, in the search space indicated by recoverySearchSpaceId of the SpCell identified by the C-RNTI. The sub-carrier spacing (SCS) for PDCCH in RAR message is the SCS for Type1-PDCCH CSS set. The SCS for any future PDSCH is also the same SCS as that of the PDSCH providing the RAR, unless the UE is configured an SCS.

Regarding step-3/step-4, for the case of CFRA or SI request, a correct reception of Msg2/RAR is the last step for the random access procedure. For the case of CBRA, multiple UEs may have used the same PRACH preamble, and further steps are needed to resolve the contention. Furthermore, for the case of random access before a UE is in the RRC_CONNECTED state (i.e., for initial access), the UE and a serving gNB need to exchange further information to set up the connection and that information is provided by a PUSCH transmission (Msg3) for contention resolution request and possibly also for connection setup request, and a PDSCH transmission (Msg4) for contention resolution response and possibly for connection setup response. The contention resolution (and connection set up, if applicable) is considered successful if the UE receives Msg4 within a certain time window after transmission of Msg3 and, for the case that the UE does not have a C-RNTI yet, if the contention resolution ID in Msg4 matches the ID that the UE transmitted in Msg3. Otherwise, the RACH attempt is considered unsuccessful, and the UE needs to perform another RACH attempt unless a configured maximum number of RACH attempts have been already exhausted in which case the entire random access procedure is declared as unsuccessful.

Instead of a 4-step RA procedure, a 2-step RA procedure can be used where a UE can transmit both a PRACH preamble and a PUSCH (MsgA) prior to reception of a corresponding RAR (MsgB).

During the initial cell search, a UE acquires/detects an SS/PBCH block transmitted by a gNB. The gNB can transmit multiple SS/PBCH blocks with different quasi-collocation properties, also referred to as beams, and the UE typically acquires the SS/PBCH block associated with the quasi-collocation properties that best match the ones of the UE. Then, assuming beam reciprocity for the DL and UL transmissions, the UE transmits PRACH according to a spatial setting that is determined from the detected SS/PBCH block.

In order to minimize an overhead associated with the SS/PBCH blocks, a gNB transmits a SS/PBCH block with a relatively wide beam in order to cover a corresponding wide area on a cell. Typically, there is a coverage imbalance between DL transmissions and UL transmissions that results due to, for example, a different antenna gain that is larger at the gNB or a different noise figure that is larger at the UE. To compensate for such coverage imbalance, the UE can transmit a PRACH with a narrower beam including changing the beam/spatial setting/spatial filters of the PRACH transmission when the UE does not detect a random-access response (RAR) message addressing the UE in response to the PRACH transmission.

The UE can also transmit multiple PRACHs, or repetitions of a PRACH preamble transmission, using different beams/spatial settings/spatial filters before the UE attempts to detect a RAR message addressing the UE in response to the PRACH transmissions. When the UE repeats the transmission of the PRACH (current PRACH transmission) using a different spatial setting after a failed attempt to detect a RAR corresponding to a previous PRACH transmission or after a previous PRACH transmission when configured to transmit multiple PRACHs before attempting the detection of corresponding RARs, the different spatial settings used for previous and current PRACH transmissions can be associated with a same SS/PBCH block. For example, the UE can be configured with multiple PRACH transmissions and transmit a number of PRACHs over corresponding ROs using different spatial settings, with a same PRACH preamble repeated over the number of PRACH transmissions or with different PRACH preambles in each PRACH transmission. The different spatial settings used for the multiple PRACH transmissions in the corresponding ROs can be associated with a same SS/PBCH block. Alternatively, the different spatial settings used for the multiple PRACH transmissions, or repetitions of a PRACH preamble transmission, in the corresponding ROs can be associated with different SS/PBCH blocks. Thus, for multiple PRACH transmissions, or repetitions of a PRACH preamble transmission, over multiple ROs using different spatial settings, the ROs can be associated to a same SS/PBCH block or with different SS/PBCH blocks. Whether the different spatial settings are associated with a same or different SS/PBCH blocks can be subject to a configuration.

When a RAR is successfully received by the UE, the UE transmits a Msg3 PUSCH. For multiple PRACH transmissions, or repetitions of a PRACH preamble transmission, with same spatial settings associated with a same SS/PBCH block, the UE can transmit the Msg3 PUSCH using the same spatial setting used for the PRACH transmission. For multiple PRACH transmissions, or repetitions of a PRACH preamble transmission, transmitted using different spatial settings associated with a same SS/PBCH block, there is a need for the UE to determine the spatial setting of each PRACH repetition in a respective RO and to determine the spatial setting for transmission of the Msg3 PUSCH so that the Msg3 PUSCH can be correctly received by the gNB.

Upon establishment of RRC connection and when the UE is provided by the gNB a configuration for PUCCH resources, the UE can transmit the PUCCH using the same spatial setting used for transmission of the Msg3 PUSCH unless otherwise indicated.

The present disclosure relates to determining a spatial setting for each repetition of a PRACH preamble transmission in a corresponding RO. The present disclosure also relates to determining a spatial setting for a Msg3 PUSCH transmission based on an indication in a RAR, and further relates to receiving the indication associated with a PRACH transmission in a RAR. The present disclosure further relates to determining a spatial setting for a PUCCH transmission with HARQ-ACK information before dedicated PUCCH resource configuration is provided based on an indication in a DCI format. The present disclosure additionally relates to indicating a spatial setting used for transmitting Msg3 PUSCH, or PUCCH before dedicated PUCCH resource configuration is provided, to a gNB.

The present disclosure provides that a UE transmits multiple PRACH transmissions, or repetitions of a PRACH preamble transmission, using different spatial settings in a number or group of ROs associated with a same SS/PBCH block but is also directly applicable when the ROs are associated with a same CSI-RS. Further, the present disclosure provides that a UE transmits multiple PRACH transmissions, or repetitions of a PRACH preamble transmission, using different spatial settings in a number or group of ROs associated with a same SS/PBCH block for the case of contention-based random access (CBRA) but is also directly applicable for the case of contention-free random access (CFRA).

Throughout the present disclosure, the terms “spatial setting,” “spatial filter,” “beam,” and “TCI” may be used interchangeably to refer to the spatial domain characteristics of a transmission and to the associated indication. Throughout the present disclosure, the terms “multiple PRACH transmissions” and “repetitions of a PRACH transmission” may be used interchangeably to refer to a PRACH transmission over multiple RACH occasions (ROs), wherein the PRACH transmission is associated with a same random access attempt.

Descriptions in this disclosure for determining a spatial setting for a Msg3 PUSCH transmission with or without repetitions or for a Msg3 PUSCH retransmission, or for any PUSCH or PUCCH transmission after a Msg3 PUSCH transmission scheduled by a RAR UL grant, when a corresponding PRACH transmission with

$${N}_{preamble}^{rep}$$

preamble repetitions uses a same spatial setting or different spatial settings, equally apply when the corresponding PRACH transmission is without repetitions or

$${N}_{preamble}^{rep} = 1.$$

Descriptions in this disclosure for determining a spatial setting for a Msg3 PUSCH transmission with or without repetitions or for a Msg3 PUSCH retransmission, when corresponding multiple PRACH transmissions with multiple PRACH preambles use a same spatial setting or different spatial settings, equally apply when a single PRACH preamble is used for the multiple PRACH transmissions. In such case, the multiple PRACH transmissions can also be referred to as multiple repetitions of a PRACH transmission (using the same PRACH preamble).

In the present disclosure, determining a spatial setting for a Msg3 PUSCH transmission based on an indication in a RAR is provided. For multiple PRACH transmissions with different spatial settings, or equivalently for multiple repetitions of a PRACH transmission with different spatial settings, a UE can transmit the multiple PRACHs over multiple ROs, or equivalently over a set or group of ROs, or on indicated or determined set of PRACH resources associated with a same SS/PBCH block. Upon reception of the SS/PBCH block, the UE can determine a number of spatial settings for a set of ROs and transmit a number of PRACHs over the set of ROs using the determined spatial settings. A gNB can indicate in a RAR the detected PRACH and the UE can transmit Msg3 PUSCH using the spatial setting associated with the detected PRACH indicated in the RAR. The indication can be an index associated with one of the multiple PRACH transmissions or, equivalently, an index of an RO or of a set of ROs where the UE transmits repetitions of the PRACH preamble using the spatial setting. For example, if the UE transmits four PRACHs, PRACHi, i={1, 2, 3, 4} in four ROs, {RO1, RO2, RO3, RO4}, using four spatial settings {s1, s2, s3, s4}, and the gNB detects PRACH2 transmitted with spatial setting s2 in RO2, the indication in a RAR can be the index i=2 corresponding to the PRACH transmission/repetition or corresponding to the associated RO. The UE then implicitly receives the indication of which spatial setting to use for the Msg3 PUSCH transmission among the multiple spatial settings used for the multiple PRACH transmissions.

For multiple PRACH transmissions with different spatial settings, a UE can transmit a PRACH with

$${N}_{preamble}^{rep}$$

preamble repetitions over multiple ROs, or equivalently over a set or group of ROs or on indicated or determined set of PRACH resources associated with a same SS/PBCH block. Upon reception of the SS/PBCH block, the UE can determine, for example based on its implementation or based on indication in a SIB, a number of spatial settings for transmission of the

$${N}_{preamble}^{rep}$$

preamble repetitions. A gNB can indicate in a RAR a preamble repetition number or an RO from the

$${N}_{preamble}^{rep}$$

preamble repetitions or respective ROs. For example, the indicated preamble repetition can be the only preamble repetition detected by the gNB, or can be the preamble repetition detected with a largest SNR by the gNB. Based on the received indication in the RAR, the UE can transmit Msg3 PUSCH, including all repetitions of Msg3 PUSCH in case the transmission is with repetitions, using the spatial setting used for the transmission of the indicated preamble repetition in corresponding PRACH occasion/RO. The indication in the RAR can be a PRACH occasion index (RO index) or a group of RO indexes where the UE transmits a PRACH repetition using a same spatial setting. For example, for a PRACH transmission with

$${N}_{preamble}^{rep} = 4$$

preamble repetitions in PRACH occasions {RO1, RO2, RO3, RO4}, using four spatial settings {s1, s2, s3, s4}, if the gNB determines that a second preamble repetition is received with higher reliability respect to other repetitions of the

$${N}_{preamble}^{rep}$$

repetitions, the indication in the RAR can be the index i=2. The UE then implicitly receives the indication of which spatial setting to use for the Msg3 PUSCH transmission among the multiple spatial settings the UE used for the PRACH transmission with

$${N}_{preamble}^{rep}$$

preamble repetitions.

Therefore, when a UE transmits multiple PRACH preambles over multiple ROs with different spatial settings, the indication of a spatial setting in a RAR would refer to a PRACH preamble or to a resource over which the UE transmits the PRACH preamble (e.g., the RO), and when a UE transmits a PRACH preamble with repetitions with different spatial settings, the indication of a spatial setting in the RAR would refer to a PRACH resource over which the UE transmits a preamble repetition (e.g., the RO).

For example, when the UE transmits four PRACH preambles or four preamble repetitions on a set or group of four ROs, and a gNB detects one of the PRACH preambles or preamble repetitions, the RAR can indicate the detected PRACH, or the RO corresponding to the detected PRACH transmission, using a 2-bit field indication. A bit value of ‘00’ indicates the first PRACH transmission, a bit value of ‘01’ indicates the second PRACH transmission and so on. It is possible that more than one PRACH is detected and the RAR indicates the PRACH received with the largest signal-to-interference and noise ratio (SINR). In general, for N preamble repetitions, the field in the RAR can include ┌log₂(N)┐ bits. In order to limit the number of bits in the RAR while allowing large values for the N preamble repetitions, a number of different spatial settings M that the UE can use to transmit PRACH preamble repetitions can be indicated to the UE, for example in a system information block (SIB) or can be defined in the specifications of the system operation, and can be smaller than a maximum number of repetitions for a PRACH preamble transmission by the UE. Additionally, a maximum number of spatial settings that the UE can use/support to transmit repetitions of a PRACH preamble, based for example on a respective UE capability, can be different than the number of spatial settings M that is indicated in the SIB. For example, the maximum number of spatial settings that the UE can use to transmit repetitions of a PRACH preamble can be two while the number of spatial settings that is indicated in the SIB can be M=4. Then, the UE can use/repeat the first and second spatial settings to match the indicated M=4 spatial settings. That approach can be directly generalized to any values of the maximum number of spatial settings that the UE can use/support to transmit repetitions of a PRACH preamble and the number of spatial settings that is indicated in the SIB.

For a first example, the specifications can define that the number of different spatial settings the UE can use to transmit PRACH repetitions is four and then the field in the RAR can have a fixed size of 2 bits. When a UE transmits a PRACH with a number of repetitions that is larger than the number of different spatial settings that the UE can use to transmit the repetitions, the UE can alternate use of different spatial settings over successive repetitions or over successive groups of repetitions.

For a second example, when the UE can transmit N preamble repetitions using M spatial settings, with N=k·M and k being an integer, the UE can transmit the first k preamble repetitions using the first spatial setting, the second k preamble repetitions using the second spatial setting, and so on, and transmit the M-th k preamble repetitions using the last, M-th, spatial setting. If N is not an integer multiple of M, the UE can use the first mod (N, M) of the M spatial settings for the last mod(N, M) preamble repetitions where mod( ) is the modulo operation and mod (N,M)=N−M└N/M┘. An advantage of the association between spatial settings and ROs in the second example is that by using a same spatial setting over k preamble repetitions/consecutive ROs, it may be possible for a serving gNB to coherently combine the received preamble repetitions thereby improving a receive SINR.

For a third example, the association among spatial settings and ROs for the repetitions of the PRACH preamble transmission can be based on UE implementation.

The association of ROs to spatial settings described in the first or second examples establishes a one-to-one mapping between └N/M┘ ROs, including the last N−M└N/M┘ ROs in case N/M is not an integer, and the M spatial settings. Therefore, the association of ROs to spatial settings described in the first or second examples can be specified in the system operation or indicated via one bit in a SIB (to indicate the association in the first example or in the second example). Then a field using ┌log₂(M)┐ bits in the RAR can indicate a spatial setting for the Msg3 PUSCH transmission that is scheduled by the UL grant in the RAR or, equivalently, can indicate an RO from M ROs having a one-to-one mapping to the M spatial settings. For the mapping in the first example, those ROs are the first M ROs having for the N PRACH preamble repetitions. For the mapping in the second example, those ROs are the first M groups of └N/M┘ ROs (the last group can include N−M └N/M ┘ ROs if N/M is not an integer).

Upon reception of the indication in RAR, the UE transmits the Msg3 PUSCH using the spatial setting used to transmit the PRACH indicated by RAR. For a UE with dedicated RRC connection, the number of spatial settings for the UE to use for transmission of PRACH preamble repetitions can be provided by UE-specific RRC signaling if the UE indicates a corresponding capability to transmit PRACH repetitions with more than one spatial settings.

It is further possible that the RAR indicates more than one PRACH preamble or RO corresponding to a preamble repetition separately. For example, if the first and third PRACH preambles or preamble repetitions are detected by the gNB, the RAR can indicate a bit value of ‘00’ and a bit value of ‘10’. Upon reception of the indication in the RAR, the UE transmits the Msg3 PUSCH using the spatial setting used to transmit either of the PRACH preamble or preamble repetition indicated by the RAR. If two PRACH preambles or ROs corresponding to preamble repetitions are indicated in the RAR, the Msg3 PUSCH can be transmitted with the spatial setting associated with one of the indicated PRACH preambles or preamble repetitions, and a retransmission of Msg3 PUSCH, if any, can use the spatial setting associated with the other indicated PRACH preamble or preamble repetition.

It is also possible that the RAR indicates more than one PRACH transmissions or occasions/ROs. In one example, if the first and second PRACHs are detected by the gNB and the third and fourth PRACHs are not detected, or if all PRACHs are detected but the first and second PRACHs are received with a higher SNR, or if at least one among the first and second PRACHs is detected and none of the third and fourth PRACHs are detected, the RAR can indicate the first and second PRACH using a 1-bit field with a bit value of ‘0’, wherein the bit value of “0” indicates first and second PRACHs and the value of “1” indicates third and fourth PRACHs, or alternatively, using a 1-bit field with a bit value of ‘1’, wherein the bit value of “1” indicates first and second PRACHs and the value of “0” indicates third and fourth PRACHs. Upon reception of the indication in the RAR, the UE transmits the Msg3 PUSCH using the spatial setting used to transmit one of the PRACHs indicated by the RAR. In one example, the UE transmits N PRACHs, and the 1-bit field in RAR indicates the first N/2 PRACHs or the second N/2 PRACHs, using the value “0” for the first N/2 PRACHs and the value “1” for the second N/2 PRACHs, or vice versa. Upon reception of the indication in RAR, the UE transmits the Msg3 PUSCH using the spatial setting used to transmit one of the N/2 PRACHs indicated by the RAR.

When a UE is provided a configuration for transmission of multiple PRACHs using different spatial settings, the UE expects to receive an indication in the RAR that indicates one of the transmitted PRACH or a corresponding RO or set of ROs.

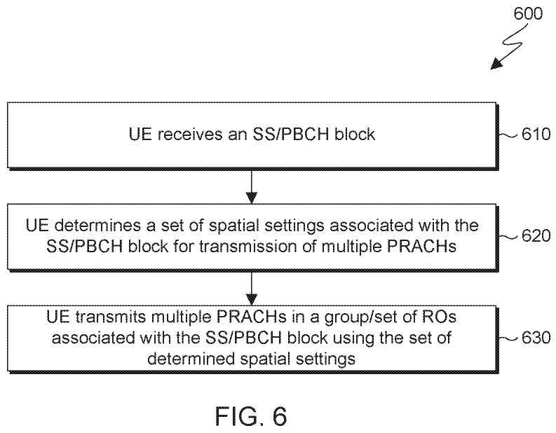

FIG. 6 illustrates a flowchart of a UE procedure 600 for determining spatial settings and ROs for transmission of multiple PRACHs according to embodiments of the present disclosure. The UE procedure 600 may be performed by a UE (e.g., any of the UEs 111-116 as illustrated in FIG. 1). An embodiment of the UE procedure 600 shown in FIG. 6 is for illustration only and does not limit the scope of this disclosure to any particular implementation. One or more of the components illustrated in FIG. 6 can be implemented in specialized circuitry configured to perform the noted functions or one or more of the components can be implemented by one or more processors executing instructions to perform the noted functions.

As illustrated in FIG. 6, at step 610, a UE receives an SS/PBCH block. At step 620, the UE determines a set of spatial settings, for example based on its implementation, associated with the SS/PBCH block for transmission of multiple PRACHs. At step 630, the UE transmits multiple PRACHs in a group/set of ROs associated with the SS/PBCH block using a spatial setting from the set of determined spatial settings.

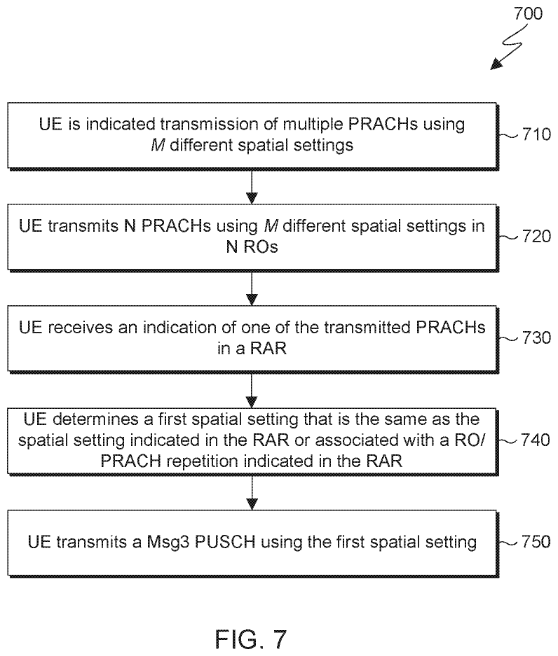

FIG. 7 illustrates a flowchart of another UE procedure 700 for determining spatial settings and ROs for transmission of multiple PRACHs according to embodiments of the present disclosure. The UE procedure 700 may be performed by a UE (e.g., any of the UEs 111-116 as illustrated in FIG. 1). An embodiment of the UE procedure 700 shown in FIG. 7 is for illustration only and does not limit the scope of this disclosure to any particular implementation. One or more of the components illustrated in FIG. 7 can be implemented in specialized circuitry configured to perform the noted functions or one or more of the components can be implemented by one or more processors executing instructions to perform the noted functions.

As illustrated in FIG. 7, at step 710, a UE is indicated transmission of multiple PRACHs using M different spatial settings. The indication can be provided in a SIB and then, if the UE is capable, the UE can transmit PRACH repetitions using more than one spatial settings. The indication in the SIB can be for a capable UE to transmit the PRACH repetitions using different spatial settings and can be ignored by other UEs. The indication in the SIB can also include the maximum number M of spatial settings for the transmission of the PRACH repetitions and that maximum number can be used to establish the association between ROs and spatial settings for the PRACH repetitions. The UE can transmit the PRACH repetitions with a number of spatial settings that is smaller than or equal to the maximum number of spatial settings. At step 720, the UE transmits N PRACHs using M different spatial settings in NROs, where M≤N. At step 730, the UE receives an indication of one of the transmitted PRACHs in a RAR. The indication can be for an RO, or for a spatial setting associated with an RO based on a predetermined association among ROs and spatial settings as was previously described in the first example or in the second example for the association among ROs and spatial settings. At step 740, the UE determines a first spatial setting that is the same as the spatial setting indicated in the RAR or associated with a RO/PRACH repetition indicated in the RAR. At step 750, the UE transmits a Msg3 PUSCH using the first spatial setting.

When a UE is provided an indication for transmission of multiple PRACHs using more than one spatial settings, transmits multiple PRACHs using more than one spatial settings over a number of ROs associated with a same SS/PBCH block, and receives an indication of a first PRACH/RO or first spatial setting in a RAR, wherein the first PRACH is transmitted using a first spatial setting, the UE transmits a Msg3 PUSCH using the first spatial setting. For a Msg3 PUSCH transmission with repetitions, the UE can transmit all repetitions using the first spatial setting. For Msg3 PUSCH retransmission, or for any other PUSCH or PUCCH transmission prior to the UE establishing a dedicated RRC connection with the gNB and is indicated spatial settings for PUSCH and PUCCH transmissions, the UE can use the same spatial setting used for the initial Msg3 PUSCH transmission. Alternatively, the UE can use a different spatial setting. For example, if the UE transmits four PRACHs with first, second, third and fourth spatial settings, respectively, the UE can transmit a Msg3 PUSCH retransmissions using spatial settings obtained by cycling through the set of spatial settings. If the UE transmits the (first) Msg3 PUSCH using the first spatial setting, the UE can transmit a retransmission, if any, using the second, third, or fourth spatial setting.

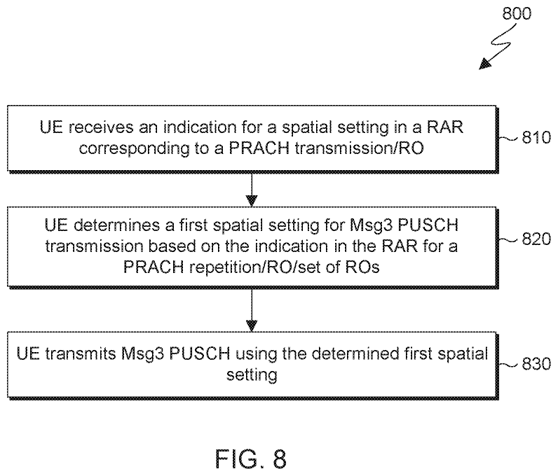

FIG. 8 illustrates a flowchart of a UE procedure 800 for determining a spatial setting for transmission of Msg3 PUSCH with repetitions according to embodiments of the present disclosure. The UE procedure 800 may be performed by a UE (e.g., any of the UEs 111-116 as illustrated in FIG. 1). An embodiment of the UE procedure 800 shown in FIG. 8 is for illustration only and does not limit the scope of this disclosure to any particular implementation. One or more of the components illustrated in FIG. 8 can be implemented in specialized circuitry configured to perform the noted functions or one or more of the components can be implemented by one or more processors executing instructions to perform the noted functions.

As illustrated in FIG. 8, at step 810, the UE receives an indication for a spatial setting in a RAR corresponding to a PRACH transmission/RO. At step 820, the UE determines a first spatial setting for Msg3 PUSCH transmission based on the indication in the RAR for a PRACH repetition/RO/set of ROs. At step 830, the UE transmits Msg3 PUSCH using the determined first spatial setting.

For multiple PRACH transmissions, a UE can also transmit a PRACH with

$${N}_{preamble}^{rep}$$

preamble repetitions over multiple ROs, or equivalently over a set or group of ROs or on an indicated or determined set of PRACH resources associated with a same SS/PBCH block using a same spatial setting or filter (for example, when a SIB does not indicate enabling of use of different spatial setting for the repetitions of a PRACH preamble transmission). Then, a RAR can still include an indication of a spatial setting for Msg3 PUSCH transmission.

In one example, the indication is whether a UE should use for Msg3 PUSCH transmission a same spatial setting as for the PRACH transmission with

$${N}_{preamble}^{rep}$$

preamble repetitions or a different spatial setting. The RAR UL grant can include a 1-bit field indication of the spatial setting for Msg3 PUSCH transmission where the value “0” can indicate to use the same spatial setting and the value “1” can indicate to use a different spatial setting, or vice versa. When the UE uses a first spatial setting for the PRACH transmission with

$${N}_{preamble}^{rep}$$

preamble repetitions and the 1-bit field in the RAR UL grant indicates to use same spatial setting for PRACH transmission and Msg3 PUSCH transmission, the UE is expected to transmit Msg3 PUSCH using the first spatial setting. When the UE uses a first spatial setting for the PRACH transmission with

$${N}_{preamble}^{rep}$$

preamble repetitions and the 1-bit field in the RAR UL grant indicates to use different spatial settings for PRACH transmission and Msg3 PUSCH transmission, the UE is not expected to transmit Msg3 PUSCH using the first spatial setting.

If the UE is indicated use of a set of spatial settings for Msg3 PUSCH transmission, the UE determines a second spatial setting from the set of spatial settings, wherein the set of spatial settings includes the first spatial setting, and the second spatial setting is different from the first spatial setting. If the set of spatial settings includes a sub-set with more than one spatial setting in addition to the first spatial setting, the UE chooses the second spatial setting from the sub-set of spatial settings based on measurements associated with receptions on the sub-set of spatial settings. If the set of spatial settings does not include the first spatial setting, the UE chooses the second spatial setting from the set of spatial settings based on measurements associated with receptions on the set of spatial settings. Then the UE transmits Msg3 PUSCH using the second spatial setting that is associated with measurements with a largest SNR. For Msg3 PUSCH transmission with repetitions, the UE can use the second spatial setting for transmission of all repetitions or can use different spatial settings from the set of spatial settings for transmission of the repetitions. For retransmissions, if any, the UE chooses a different spatial setting than the one used for the initial transmission or previous retransmission(s), and the selection of the spatial setting for the retransmission can be based on measurements with largest SNR among the set of spatial settings not including the spatial setting used for the initial transmission or previous retransmission(s).

If the UE is not indicated use of a set of spatial settings for Msg3 PUSCH transmission, the UE can determine a second spatial setting based on measurements and transmits the Msg3 PUSCH (with or without repetitions) with the second spatial setting, or determines a set of spatial settings that may or may not include the first spatial setting and transmits Msg3 PUSCH with repetitions using the set of spatial settings over the repetitions, or transmits Msg3 PUSCH retransmission using the set of spatial settings over the retransmissions.

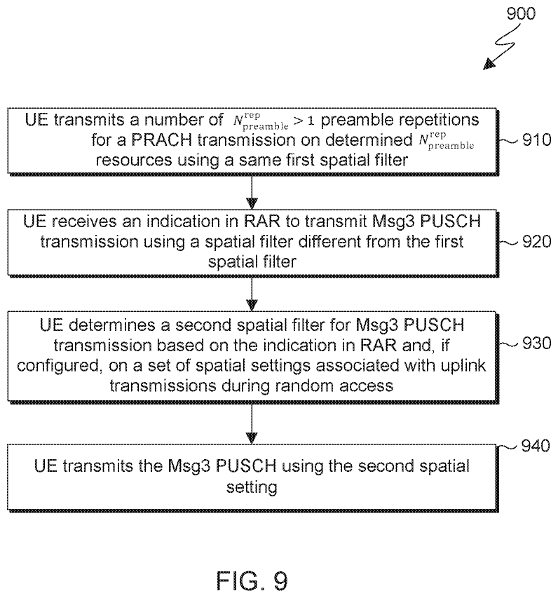

FIG. 9 illustrates a flowchart of a UE procedure 900 for determining a spatial setting for Msg3 PUSCH transmission according to embodiments of the present disclosure. The UE procedure 900 may be performed by a UE (e.g., any of the UEs 111-116 as illustrated in FIG. 1). An embodiment of the UE procedure 900 shown in FIG. 9 is for illustration only and does not limit the scope of this disclosure to any particular implementation. One or more of the components illustrated in FIG. 9 can be implemented in specialized circuitry configured to perform the noted functions or one or more of the components can be implemented by one or more processors executing instructions to perform the noted functions.

As illustrated in FIG. 9, at step 910, a UE transmits a number of

$${N}_{preamble}^{rep} > 1$$

preamble repetitions for a PRACH transmission on determined

$${N}_{preamble}^{rep}$$

resources using a same first spatial filter. At step 920, the UE receives an indication in a RAR to transmit Msg3 PUSCH transmission using a spatial filter different from the first spatial filter. At step 930, the UE determines a second spatial filter for Msg3 PUSCH transmission based on the indication in the RAR and, if configured, on a set of spatial settings associated with uplink transmissions during random access. At step 940, the UE transmits Msg3 PUSCH using the second spatial setting. Steps 920 to 940 also apply when the UE transmits a PRACH on an indicated PRACH resource using the first spatial setting.

In the present disclosure, indication of a spatial setting by a UE is provided.

When a UE is configured use of a set of spatial settings for uplink transmission during random access, for example for PRACH transmission or Msg3 PUSCH transmission or PUCCH transmission that provides HARQ-ACK information in response to a PDSCH reception during a random access procedure (e.g., Msg4 reception), the UE can determine a spatial setting from the set of spatial settings and transmit Msg3 PUSCH or PUCCH using the determined spatial setting. The UE can also indicate the spatial setting to a gNB.

In one example, the UE is configured with a set of spatial settings for transmission during random access and determines a spatial setting from the set of spatial setting for Msg3 PUSCH transmission. The UE then transmits Msg3 PUSCH using the spatial setting and indicates the spatial setting to a gNB. A field in a Msg3 PUSCH, such as a MAC control element (CE) or as multiplexed uplink control information (UCI) similar to multiplexing HARQ-ACK or CSI, can indicate the spatial setting used by the UE to transmit Msg3 PUSCH, wherein the field in the Msg3 PUSCH can be a dedicated field, or a field repurposed to indicate the spatial setting. The field can be one or more bits depending on the number of configured spatial settings. The spatial setting can correspond to a TCI state from a set of TCI states indicated in a SIB associated with a SS/PBCH block the UE uses to obtain time-frequency synchronization and subsequently receive the SIB.

For example, if the UE is provided four spatial settings/TCI states by a higher layer parameter or in a SIB, the UE uses 2 bits to indicate one of the four spatial settings that is used for the Msg3 PUSCH transmission. If the UE transmits Msg3 PUSCH with repetitions, the UE uses the same spatial setting for transmission of the Msg3 PUSCH repetitions. The UE also uses the same spatial setting for transmission of a PUCCH that provides HARQ-ACK information in response to a PDSCH reception scheduled by a DCI format 1_0 with CRC scrambled by a TC-RNTI for a Type-1 RA procedure, or provides HARQ-ACK information having ACK value if the RAR message(s) is for successRAR for a Type-2 RA procedure or, in general, HARQ-ACK information before receiving information by UE-specific RRC signaling for PUCCH resources. The UE can also use the same spatial setting for all subsequent PUCCH transmissions with HARQ-ACK information prior to the UE being provided dedicated PUCCH resources that include respective spatial settings.

In one example, the UE is configured use of a set of spatial settings for transmission during random access and determines a spatial setting from the set of spatial setting for a PUCCH that provides HARQ-ACK information in response to a PDSCH reception scheduled by a DCI format 1_0 with CRC scrambled by a TC-RNTI for a Type-1 RA procedure or with a C-RNTI for a PDSCH received after contention resolution, or provides HARQ-ACK information having ACK value if the RAR message(s) is for successRAR for a Type-2 RA procedure or, in general, HARQ-ACK information before receiving information by UE-specific RRC signaling for PUCCH resources. The UE then transmits PUCCH using the spatial setting. The UE can also indicate the spatial setting to a gNB as that can enable the gNB to subsequently use a narrower beam for transmitting to the UE. A field in a PUCCH can indicate the spatial setting used by the UE to transmit PUCCH, wherein the field can be a dedicated field, or a field repurposed to indicate the spatial setting. The field can be one or more bits in the PUCCH with the HARQ-ACK information depending on the number of configured spatial settings. For example, if the UE is provided four spatial settings, for example via corresponding TCI states in a SIB associated with a SS/PBCH block, the UE uses 2 bits to indicate one of the four spatial settings that is used for the PUCCH transmission. If the UE transmits PUCCH with repetitions, the UE uses the same spatial setting for transmission of the PUCCH repetitions. The bits indicating the spatial setting can also be multiplexed in a PUSCH transmission similar to HARQ-ACK information and, in case the UE also provides HARQ-ACK information, the bits can be appended to the HARQ-ACK information prior to encoding.

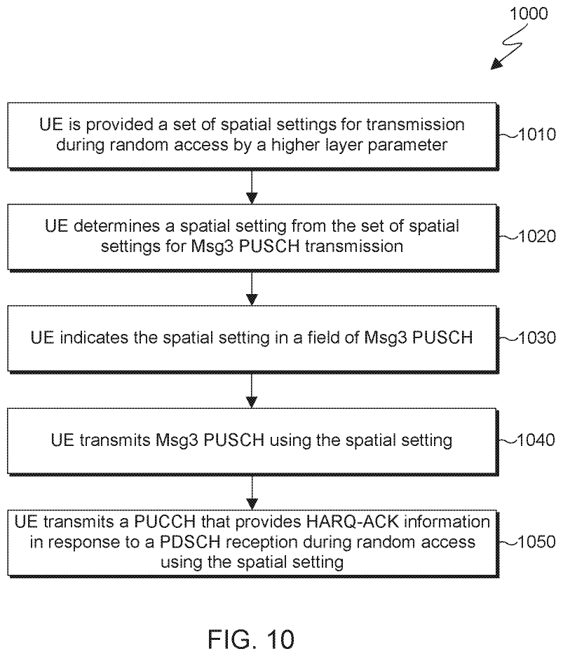

FIG. 10 illustrates a flowchart of a UE procedure 1000 for indicating a spatial setting used for Msg3 PUSCH transmission according to embodiments of the present disclosure. The UE procedure 1000 may be performed by a UE (e.g., any of the UEs 111-116 as illustrated in FIG. 1). An embodiment of the UE procedure 1000 shown in FIG. 10 is for illustration only and does not limit the scope of this disclosure to any particular implementation. One or more of the components illustrated in FIG. 10 can be implemented in specialized circuitry configured to perform the noted functions or one or more of the components can be implemented by one or more processors executing instructions to perform the noted functions.

As illustrated in FIG. 10, at step 1010, a UE is provided a set of spatial settings for transmission during random access by a higher layer parameter in a SIB. At step 1020 the UE determines a spatial setting from the set of spatial settings for a PRACH or a Msg3 PUSCH transmission. At step 1030, the UE indicates the spatial setting in a field of Msg3 PUSCH. At step 1040, the UE transmits Msg3 PUSCH using the spatial setting. At step 1050, the UE transmits a PUCCH that provides HARQ-ACK information in response to a PDSCH reception during random access using the spatial setting.

In the present disclosure, indication of a spatial setting for Msg3 PUSCH transmission in a RAR is provided. For a Msg3 PUSCH transmission that is part of a random access procedure that a UE performs for initial access to the gNB, or after the UE establishes an RRC connection with the gNB, the UE can determine a spatial setting based on an indication in a RAR, wherein the indication is associated with one or more of the multiple PRACHs transmitted using different spatial settings over ROs associated with a same SS/PBCH block or CSI-RS. The UE can receive the indication in a DCI format in a new field of one, two or more bits. It is possible that the indication is provided by the DCI format/RAR UL grant by re-purposing bits of existent fields to avoid an overhead in the DCI format that is associated with introducing a new field. Additionally, or alternatively, different spatial settings can be associated with different SS/PBCH blocks or CSI-RS configurations. For example, the UE receives CSI-RS configurations associated with corresponding spatial settings in a SIB.

For a Msg3 PUSCH retransmission, if any, scheduled by a DCI format 0_0 with CRC scrambled by a TC-RNTI provided in the corresponding RAR message, the UE can determine a spatial setting based on an indication in a field of the DCI format 0_0. The UE can be configured a 1-bit field in DCI format 0_0 for the indication of the spatial setting for Msg3 PUSCH retransmission, and the 1-bit field of value “0” indicates to use the same spatial setting used in the previous Msg3 PUSCH transmission and of value “1” indicates to use a different spatial setting from the spatial setting used in the previous Msg3 PUSCH transmission, or vice versa. Alternatively, when the UE is configured a 1-bit field in DCI format 0_0 for the indication of the spatial setting for Msg3 PUSCH retransmission, the 1-bit field is set to “0” (or to “1”) to indicate to use a different spatial setting from the spatial setting used in the previous Msg3 PUSCH transmission. Alternatively, the 1-bit field of the DCI format 0_0 scheduling a Msg3 PUSCH retransmission can indicate a spatial setting from a set of configured spatial setting. When the UE is configured a set of spatial settings including more than two spatial settings, the field of the DCI format 0_0 for the indication of the spatial setting has more than one bit.

When a UE transmits a Msg3 PUSCH, a high order modulation and a high code rate targeting high spectral efficiency for the data information is typically inapplicable. Therefore, only lower entries of a modulation and coding scheme (MCS) table that can be indicated by an MCS field in a DCI format scheduling a PUSCH transmission can be useful. For example, the MCS table can be one that includes smaller spectral efficiency values for a PUSCH transmission instead of one that includes larger spectral efficiency values. For example, for an MCS field that comprises of 4 bits or comprises of 5 bits, 1 or more bits can be used as part of a number of bits that are used to indicate an index associated with a PRACH transmission.

For a Msg3 PUSCH transmission scheduled by an UL grant in a RAR, the indication of the index (repetition number or RO) associated with the PRACH transmission for the determination of the spatial setting of the Msg3 PUSCH transmission can be provided by the RAR. For example, the 2 MSBs of the MCS field or the 2 LSBs of the MCS field can be used to indicate the repetition number/RO for determining a same spatial setting for the Msg3 PUSCH transmission as the spatial setting use to transmit the repetition in the RO, and the remaining 2 bits or 3 bits provide an MCS index. When 2 bits are used for the indication of the index (repetition number or RO) associated with the PRACH transmission, for each MCS index the corresponding PUSCH transmission can be indicated with any of the 4 indexes associated with the PRACH transmissions. In another example, the 3 MSBs of the MCS field or the 3 LSBs of the MCS field can be used for the indication of the index (repetition number or RO) associated with the PRACH transmission, for the UE to transmit the Msg3 PUSCH using a same spatial setting as the one used to transmit the repetition of the PRACH preamble for the repetition number/RO, and the remaining 1 bit or 2 bits provide an MCS index.

A PUSCH associated with an MCS index can be transmitted with any of the spatial settings used for the PRACH transmission corresponding to the index indicated by bits of the MCS field.

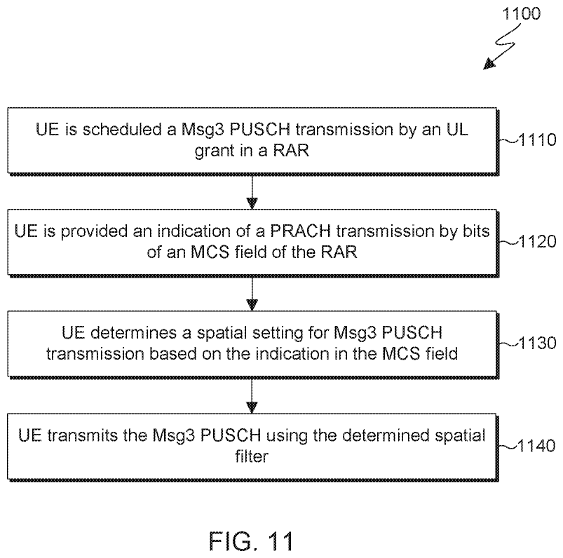

FIG. 11 illustrates a flowchart of a UE procedure 1100 for determining a spatial setting for a Msg3 PUSCH transmission that is scheduled by an UL grant in a RAR message according to embodiments of the present disclosure. The UE procedure 1100 may be performed by a UE (e.g., any of the UEs 111-116 as illustrated in FIG. 1). An embodiment of the UE procedure 1100 shown in FIG. 11 is for illustration only and does not limit the scope of this disclosure to any particular implementation. One or more of the components illustrated in FIG. 11 can be implemented in specialized circuitry configured to perform the noted functions or one or more of the components can be implemented by one or more processors executing instructions to perform the noted functions.

As illustrated in FIG. 11, at step 1110, a UE is scheduled a Msg3 PUSCH transmission by an UL grant in a RAR. At step 1120, the UE is provided an indication of a PRACH transmission (repetition number or RO) by bits of an MCS field of the RAR. At step 1130, the UE determines a spatial setting for Msg3 PUSCH transmission based on the indication in the MCS field. At step 1140, the UE transmits the Msg3 PUSCH using the determined spatial filter.

A transmission power control (TPC) command field in the DCI format scheduling the Msg3 PUSCH transmission can be fully or partially used to indicate an RO index for a spatial setting associated with a PRACH transmission. For example, for a TPC command field for 2 bits, a value can be used to indicate one of four values for the RO index for the UE to determine a same spatial setting for the Msg3 PUSCH transmission.

For a Msg3 PUSCH transmission that provides a small transport block, a benefit from incremental redundancy over chase combining is marginal. Therefore, some or all bits of an RV field in a DCI format scheduling the Msg3 PUSCH transmission can be used to indicate an RO index, or equivalently a spatial setting, associated with a PRACH transmission in the RO.

When a UE transmits a PUSCH with repetitions, a large bandwidth for the Msg3 PUSCH transmission is unlikely as the power spectral density per RE becomes smaller and channel estimation accuracy degrades. Therefore, a maximum PUSCH transmission bandwidth can be configured, for example by a SIB, and a frequency domain resource allocation (FDRA) field in a DCI format scheduling the Msg3 PUSCH transmission can have some of its bits, such as 1 or 2 MSBs, repurposed to indicate an RO index, or equivalently a spatial setting, associated with a PRACH transmission in the RO.

Therefore, prior to establishing an RRC connection, an RO index or a spatial setting associated with a PRACH transmission in the RO can be indicated by a DCI format scheduling the PUSCH transmission by using one or more bits of one or more existing fields in the DCI format such as the MCS field, the TPC command field, the RV field, or the FDRA field. A bit from the aforementioned fields can be used to indicate an interpretation for the remaining bits as being a conventional one associated with the functionality of those fields or as indicating a number of repetitions. The bits can be defined in the specification of the system operation.

For a Msg3 PUSCH transmission that is scheduled by an UL grant in a random access response (RAR) message, an indication of an RO index, or of a spatial setting associated with a PRACH transmission in the RO, for use in the Msg3 PUSCH transmission can additionally include reserved bits such as a bit used to request a channel state information (CSI) report for a UE that performs a random access procedure after RRC connection setup.

In the present disclosure, indication of a spatial setting for a PUCCH transmission with HARQ-ACK information before dedicated PUCCH resources configuration can be provided in a DCI format. A DCI format can indicate a spatial setting for a PUCCH transmission with HARQ-ACK information before dedicated PUCCH resource configuration is provided using one or more bits from the payload of the DCI format. A DCI format, such as DCI format 1_0, scheduling a PDSCH reception can include a dedicated field for indicating a spatial setting for a PUCCH transmission that provides HARQ-ACK information for the PDSCH reception, or the one or more bits used for indicating a spatial setting for the PUCCH transmission are obtained from fields that exist in DCI format 1_0. Alternatively, the UE transmit the PUCCH with a same spatial setting as the one the UE is indicated for a last Msg3 PUSCH transmission at a time prior to the PUCCH transmission without any indication for a spatial setting for the PUCCH transmission being provided in a DCI format associated with the PUCCH transmission.

In one example, some or all bits used for indicating a spatial setting for a PUCCH transmission from a UE can be provided by a HARQ process number (HPN) field in a DCI format such as DCI format 1_0. A HPN field in the DCI format includes 4 bits to indicate one from 16 HARQ processes that is associated with a transport block (TB) provided by a PDSCH reception that is scheduled by the DCI format. When the UE is not indicated by UE-specific RRC signaling a number of HARQ processes, such as prior to establishing RRC connection with a serving gNB, a maximum number of HARQ processes is 8 and 1 bits from the HPN field, such as the most significant bit (MSB), can be used for indicating a spatial setting for an associated PUCCH transmission. As a UE without RRC connection with the serving gNB is unlikely to require high data rates for communicating with the gNB, a number of HARQ processes can be smaller than 8, such as 4, and then 2 bits from the HPN field can be used for indicating a spatial setting.

In one example, a large modulation order, such as QAM64, or a large code rate, such as above ⅔, targeting high spectral efficiency or large data rates for PDSCH receptions by a UE are typically not applicable prior to the UE establishing RRC connection with a serving gNB. Therefore, only lower entries of a modulation and coding scheme (MCS) table that can be indicated by an MCS field in a DCI format, such as DCI format 1_0, scheduling a PDSCH reception can be useful. For example, for a MCS field of 5 bits, one or more bits can be used for indicating a spatial setting for the PUSCH transmission through an indication of a PRACH repetition number or of an RO or of a subset of ROs as previously described.

In one example, a transmission power control (TPC) command field in a DCI format, such as DCI format 1_0, can be fully or partially used to indicate a spatial setting. For example, for a TPC command field of 2 bits, a value can indicate a spatial setting from a set of spatial settings based on a (maximum) number of spatial settings indicated by a SIB. For example, for a TPC command field for 2 bits, one bit can be used to indicate a power adjustment of 0 dB or 3 dB while the other bit can be used to indicate a spatial setting, or can be combined with a bit of another field, such as the HPN field or the MCS field, to indicate a spatial setting, for example, through the indication of an associated RO or subset of ROs.

In one example, considering that PDSCH receptions prior to a UE establishing an RRC connection with a serving gNB are typically with low code rate and provide TBs with small sizes, use of incremental redundancy for a retransmission of a TB (when the UE indicates a NACK value for a previous transmission of the TB), can be avoided (chase combining is then used) or reduced such as by using one redundancy version (RV) instead of three RVs since practically all gains from HARQ retransmissions of a TB can be obtained with chase combining or with one additional RV for incremental redundancy. For example, for a DCI format 1_0 that includes an RV field of 2 bits, one bit can be used to indicate RV 0 or RV 2, and one bit can be used to indicate a spatial setting, or can be used in combination with one or more bits from another field as previously described. Alternatively, if chase combining is used for HARQ retransmissions of a TB, both bits of the RV field in DCI format 1_0 can be used for indicating a spatial setting for a PUCCH transmission associated with DCI format 1_0. The indication can be based on an indication of a PRACH repetition number or of an RO or of a subset of ROs associated with the use of the spatial setting.

In one example, 1 or more bits of a downlink assignment index (DAI) field of the DCI format 1_0 that comprises 2 bits can be used as part of a number of bits that are used to indicate a spatial setting for the PUCCH transmission, or 1 or 2 bits of a field of 2 reserved bits when the DCI format is monitored in common search space for operation in a cell in frequency range 2-2 and the number of bits for the field of ‘ChannelAccess-CPext’ is 0 can be used.

A spatial setting for a PUCCH transmission from a UE when the UE is not provided PUCCH resources by UE-specific RRC signaling can be indicated by a DCI format scheduling the PDSCH transmission by using one or more bits of one or more existing fields in the DCI format such as the HARQ process number field, the MCS field, the TPC command field, or the RV field, wherein the DCI format can be DCI format 1_0 or DCI format 1_1 or DCI format 1_2. A bit from the aforementioned fields can be used to indicate whether or not the spatial setting for the PUCCH transmission is same or different than the spatial setting used for Msg3 PUSCH transmission when the UE is not provided PUCCH resources by UE-specific RRC signaling and then an interpretation for the remaining bits can be determined as being a conventional one associated with the functionality of those fields. Alternatively, the use of one more bits from the aforementioned fields can be defined in the specifications of the system operation as being used to indicate a spatial setting for a PUCCH transmission from a UE when the UE is not provided PUCCH resources by UE-specific RRC signaling.

To indicate the spatial setting for a PUCCH transmission before dedicated PUCCH resource configuration is provided, a number of bits in a DCI format can comprise bits from more than one of the HARQ process number, MCS, TPC, or RV fields, and can be the MSB or the LSB of the corresponding field. If the two or more bits for the indication of the spatial setting for the PUCCH transmission are from a same field of the DCI format 1_0, the two or more MSBs or the two or more LSBs of that field can be used and that can be defined in the specifications of the system operation. For example, two bits of the HPN field, or the MSB of the HPN field and the MSB of the MCS field, or the two MSBs of the MCS field, or the MSB of the HPN field and the MSB of the RV field, and so on, can be used.

Instead of DCI format scheduling a PDSCH reception indicating a spatial setting for an associated PUCCH transmission, the spatial setting can be indicated by a MAC CE provided by the PDSCH reception. The MAC CE can indicate an index in a set of K values provided by a higher layer parameter.

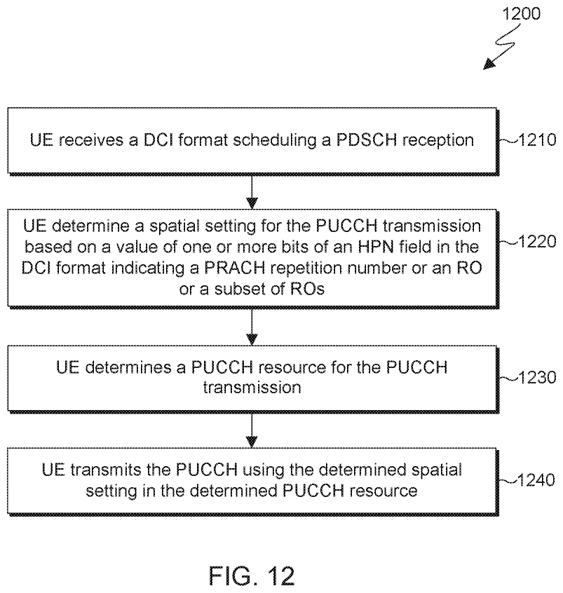

FIG. 12 illustrates a flowchart of a UE procedure 1200 for transmitting a PUCCH before dedicated PUCCH resource configuration is provided using a spatial setting indicated by bits of a HARQ process number field in a DCI format scheduling a PDSCH reception according to embodiments of the present disclosure. The UE procedure 1200 may be performed by a UE (e.g., any of the UEs 111-116 as illustrated in FIG. 1). An embodiment of the UE procedure 1200 shown in FIG. 12 is for illustration only and does not limit the scope of this disclosure to any particular implementation. One or more of the components illustrated in FIG. 12 can be implemented in specialized circuitry configured to perform the noted functions or one or more of the components can be implemented by one or more processors executing instructions to perform the noted functions.

As illustrated in FIG. 12, at step 1210, a UE receives a DCI format scheduling a PDSCH reception. At step 1220, the UE determines a spatial setting for the PUCCH transmission based on a value of one or more bits of an HPN field in the DCI format indicating a PRACH repetition number or an RO or a subset of ROs. At step 1230, the UE determines a PUCCH resource for the PUCCH transmission. At step 1240, the UE transmits the PUCCH using the determined spatial filter in the determined PUCCH resource.

A UE that indicates a capability to transmit with repetitions a PUCCH with HARQ-ACK information and does not have dedicated PUCCH resource configuration, determines a number of repetitions for the PUCCH transmission based on an indication by a higher layer parameter numberOfPUCCHforMsg4HARQACK-RepetitionsList and, if the higher layer parameter numberOfPUCCHforMsg4HARQACK-RepetitionsList provides more than one value, by the DAI field of a DCI format scheduling a PDSCH reception. The UE can determine a spatial setting for the PUCCH transmission based on an indication by a field in the DCI format. It is possible that the UE determines a spatial setting based on an indicated number of repetitions. The UE can be provided a spatial setting associated to a number of repetitions by a higher layer parameter, and an indication of the number of repetitions also provides the information of the spatial setting for the PUCCH transmission. Alternatively, the UE can transmit any PUCCH with a same spatial setting as the one the UE used to transmit a last Msg3 PUSCH.

In one example, a UE is configured one value for the number of repetitions by numberOfPUCCHforMsg4HARQACK-RepetitionsList and an associated spatial setting by a same or different higher layer parameter. An indication of the number of repetitions also provides implicitly a spatial setting for the PUCCH transmission with the indicated number of repetitions.

In one example, a UE is configured N values for the number of repetitions by numberOfPUCCHforMsg4HARQACK-RepetitionsList and N spatial settings associated with the N values for the number of repetitions by a same or different higher layer parameter, wherein the N spatial settings can be all different spatial settings or same or all spatial settings can be the same. An indication of the number of repetitions can also provide implicitly the spatial setting for the PUCCH transmission with the indicated number of repetitions. N can be 1 or an integer value larger than 1.

In one example, a UE is configured N spatial settings by a higher layer parameter, for example PUCCH-SpatialSetting-List, and if PUCCH-SpatialSetting-List has more than one entry, a field in the DCI format, as previously described, indicates a spatial setting from the N spatial settings.

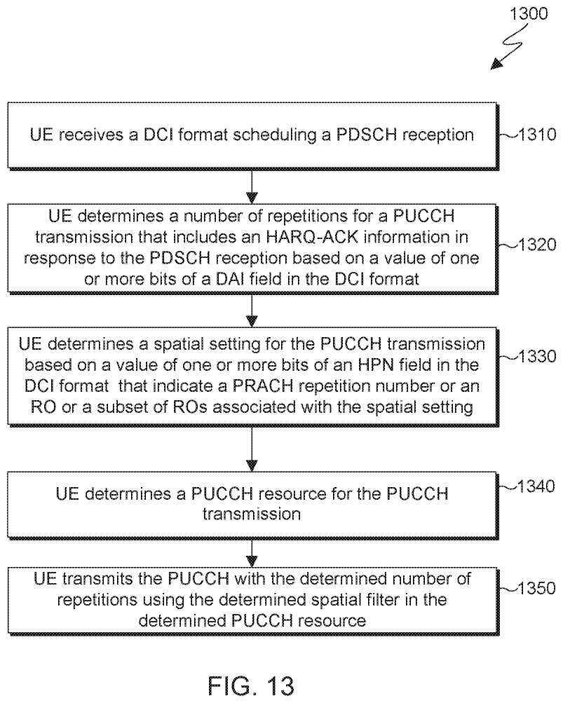

FIG. 13 illustrates a flowchart of a UE procedure 1300 for transmitting a PUCCH before dedicated PUCCH resource configuration is provided using a number of repetitions and a spatial setting that are indicated by a DCI format scheduling a PDSCH reception, wherein the DCI format is with CRC scrambled by a TC-RNTI and the PDSCH reception includes a UE contention resolution identity according to embodiments of the present disclosure. The UE procedure 1300 may be performed by a UE (e.g., any of the UEs 111-116 as illustrated in FIG. 1). An embodiment of the UE procedure 1300 shown in FIG. 13 is for illustration only and does not limit the scope of this disclosure to any particular implementation. One or more of the components illustrated in FIG. 13 can be implemented in specialized circuitry configured to perform the noted functions or one or more of the components can be implemented by one or more processors executing instructions to perform the noted functions.

As illustrated in FIG. 13, at step 1310, a UE receives a DCI format scheduling a PDSCH reception. At step 1320, the UE determines a number of repetitions for a PUCCH transmission that includes an HARQ-ACK information in response to the PDSCH reception based on a value of one or more bits of a DAI field in the DCI format. At step 1330, the UE determines a spatial setting for the PUCCH transmission based on a value of one or more bits of an HPN field in the DCI format that indicate a PRACH repetition number or an RO or a subset of ROs associated with the spatial setting. At step 1340, the UE determines a PUCCH resource for the PUCCH transmission. At step 1350, the UE transmits the PUCCH with the determined number of repetitions using the determined spatial filter in the determined PUCCH resource.

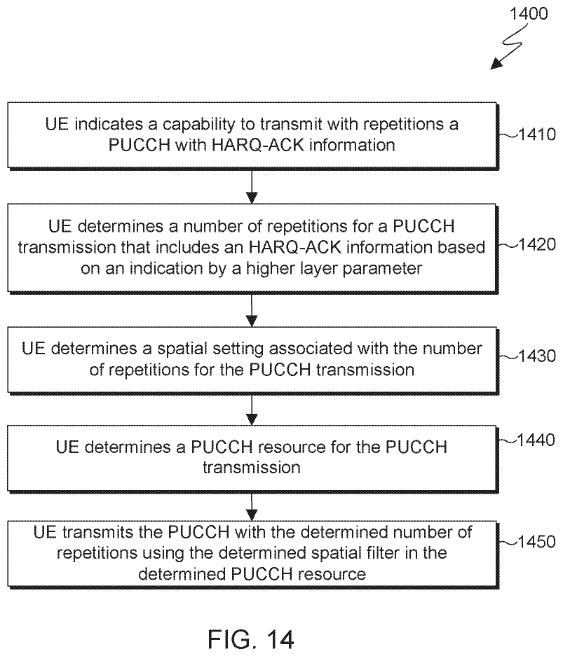

FIG. 14 illustrates a flowchart of a UE procedure 1400 for transmitting a PUCCH before dedicated PUCCH resource configuration is provided using a number of repetitions and an associated spatial setting according to embodiments of the present disclosure. The UE procedure 1400 may be performed by a UE (e.g., any of the UEs 111-116 as illustrated in FIG. 1). An embodiment of the UE procedure 1400 shown in FIG. 14 is for illustration only and does not limit the scope of this disclosure to any particular implementation. One or more of the components illustrated in FIG. 14 can be implemented in specialized circuitry configured to perform the noted functions or one or more of the components can be implemented by one or more processors executing instructions to perform the noted functions.

As illustrated in FIG. 14, at step 1410, a UE indicates a capability to transmit with repetitions a PUCCH with HARQ-ACK information. At step 1420, the UE determines a number of repetitions for a PUCCH transmission that includes an HARQ-ACK information based on an indication by a higher layer parameter. At step 1430, the UE determines a spatial setting associated with the number of repetitions for the PUCCH transmission. At step 1440, the UE determines a PUCCH resource for the PUCCH transmission. At step 1450, the UE transmits the PUCCH with the determined number of repetitions using the determined spatial filter in the determined PUCCH resource.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method for a user equipment (UE) to transmit a physical random access channel (PRACH), the method comprising:
receiving a system information block (SIB) that indicates:
random access channel occasions (ROs), and
a set of numbers of repetitions for the PRACH;
determining L groups of ROs, wherein each of the L groups of ROs comprises M ROs for respective M repetitions using respective M spatial settings for the PRACH, based on:
a number N of repetitions from the set of numbers of repetitions, and
a UE capability to transmit M repetitions using respective M spatial settings, wherein Mis larger than one;
transmitting the PRACH over the L groups of ROs, with M repetitions and respective M spatial settings over M ROs for each of the L groups of ROs;
receiving a random access response (RAR), wherein:
the RAR includes information scheduling transmission of a physical uplink channel (PUSCH), and
the information includes a channel state information (CSI) report request field;
determining an RO, from the M ROs of any of the L groups of ROs, based on a value of the CSI report request field; and
transmitting the PUSCH using a spatial setting, from the M spatial settings, corresponding to the RO.

2. The method of claim 1, further comprising:
determining the RO based on a value of one or two most significant bits (MSBs) of a frequency domain resource allocation (FDRA) field, wherein the information further includes the FDRA field.

3. The method of claim 1, further comprising:
transmitting the PUSCH with more than one repetitions using the spatial setting for each of the more than one repetitions.

4. The method of claim 1, further comprising:
receiving a physical downlink shared channel (PDSCH); and
transmitting a physical uplink control channel (PUCCH) using the spatial setting, wherein the PUCCH provides hybrid automatic repeat request acknowledgement (HARQ-ACK) information associated with the PDSCH.

5. The method of claim 1, further comprising:
receiving downlink control information scheduling a retransmission of the PUSCH; and
transmitting the PUSCH using the spatial setting.

6. The method of claim 1, wherein the M ROs have consecutive indexes.

7. The method of claim 1, wherein the SIB further indicates an enabling to transmit the PRACH with repetitions using more than one spatial settings.

8. The method of claim 1, further comprising:
receiving a synchronization signal and primary broadcast channel (SS/PBCH) block,
wherein the SIB is associated with the SS/PBCH block, and
wherein each of the M spatial settings is associated with the SS/PBCH block.

9. A user equipment (UE) comprising:
a transceiver configured to receive a system information block (SIB) that indicates:
random access channel occasions (ROs), and
a set of numbers of repetitions for a physical random access channel (PRACH); and
a processor, operably coupled to the transceiver, the processor configured to determine L groups of ROs, wherein each of the L groups of ROs comprises MROs for respective M repetitions using respective M spatial settings for the PRACH, based on:
a number N of repetitions from the set of numbers of repetitions, and
a UE capability to transmit M repetitions using respective M spatial settings, wherein M is larger than one,
wherein the transceiver is further configured to:
transmit the PRACH over the L groups of ROs, with M repetitions and respective M spatial settings over M ROs for each of the L groups of ROs; and
receive a random access response (RAR), wherein:
the RAR includes information scheduling transmission of a physical uplink channel (PUSCH), and
the information includes a channel state information (CSI) report request field;
wherein the processor is further configured to determine an RO, from the MROs of any of the L groups of ROs, based on a value of the CSI report request field; and
wherein the transceiver is further configured to transmit the PUSCH using a spatial setting, from the M spatial settings, corresponding to the RO.

10. The UE of claim 9, wherein the processor is further configured to determine the RO based on a value of one or two most significant bits (MSBs) of a frequency domain resource allocation (FDRA) field, wherein the information further includes the FDRA field.

11. The UE of claim 9, wherein the transceiver is further configured to transmit the PUSCH with more than one repetitions using the spatial setting for each of the more than one repetitions.

12. The UE of claim 9, wherein the transceiver is further configured to:
receive a physical downlink shared channel (PDSCH); and
transmit a physical uplink control channel (PUCCH) using the spatial setting, wherein the PUCCH provides hybrid automatic repeat request acknowledgement (HARQ-ACK) information associated with the PDSCH.

13. The UE of claim 9, wherein the transceiver is further configured to:
receive downlink control information scheduling a retransmission of the PUSCH; and
transmit the PUSCH using the spatial setting.

14. The UE of claim 9, wherein the M ROs have consecutive indexes.

15. The UE of claim 9, wherein the SIB further indicates an enabling to transmit the PRACH with repetitions using more than one spatial settings.

16. The UE of claim 9, wherein:
the transceiver is further configured to receive a synchronization signal and primary broadcast channel (SS/PBCH) block,
the SIB is associated with the SS/PBCH block, and
each of the M spatial settings is associated with the SS/PBCH block.

17. A base station (BS) comprising:
a transceiver configured to transmit a system information block (SIB) that indicates:
random access channel occasions (ROs), and
a set of numbers of repetitions for a physical random access channel (PRACH); and
a processor, operably coupled to the transceiver, the processor configured to determine L groups of ROs,
wherein the transceiver is further configured to:
receive the PRACH over the L groups of ROs, wherein each of the L groups of ROs comprises M ROs for respective M repetitions for the PRACH;
transmit a random access response (RAR), wherein:
the RAR includes information scheduling transmission of a physical uplink channel (PUSCH),
the information includes a channel state information (CSI) report request field, and
a value of the CSI report request field indicates an RO from the M ROs of any of the L groups of ROs; and
receive the PUSCH.

18. The BS of claim 17, wherein:
the information further includes a frequency domain resource allocation (FDRA) field, and
one or two most significant bits (MSBs) of the FDRA field indicate the RO.

19. The BS of claim 17, wherein the M ROs have consecutive indexes.

20. The BS of claim 17, wherein the SIB further indicates an enabling to receive the PRACH over the L groups of ROs.
